(19) United States
(12) Patent Application Publication
(10) Pub. No.: US 2010/0292885 A1
(43) Pub. Date: Nov. 18, 2010

(54) Control Unit and Method for Trigger Passenger Protection Means

(75) Inventor: Marcus Hiemer, Kehlen (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 12/308,332

(22) PCT Filed: Dec. 13, 2007
(86) PCT No.: PCT/EP2007/063853

§ 371 Date: Aug. 2, 2010

(30) Foreign Application Priority Data
Jan. 19, 2007 (DE) 10 2007 002 834.4

(51) Int. Cl. B60R 21/01

(52) U.S. Cl. 701/29; 701/45

(57) ABSTRACT

A control unit and a method for triggering a passenger protection arrangement are described, a first hardware path and a second hardware path together inducing the triggering on the basis of at least one accident signal from an accident sensor system. An analyzer circuit for processing the at least one accident signal is present in the first hardware path, and a plausibility circuit is present in the second hardware path. At least the plausibility circuit is additionally connected to an interface, the interface supplying a signal of at least one additional control unit. The plausibility circuit also enables the triggering as a function of this signal.

### FIELD OF THE INVENTION

The present invention relates to a control unit and a method for triggering a passenger protection arrangement.

### BACKGROUND INFORMATION

German patent document DE 10 2004 020 681 A1 discusses a device for triggering a passenger protection device. A sensor signal is processed by a microcontroller and a safety semiconductor SCON in parallel. The accident sensor system includes, for example, an acceleration sensor system and/or a pressure sensor system. A surroundings sensor system, a contact sensor system or a combination thereof is also possible. The microcontroller and the safety semiconductor both control a triggering circuit as a function of their analysis of the sensor values, which ultimately results in energization of the ignition elements for the passenger protection device. In other words, only when the microcontroller and the safety semiconductor both detect a deployment case necessitating triggering of the passenger protection device will the triggering circuit perform the energization.

### SUMMARY OF THE INVENTION

The control unit according to the present invention and the method according to the present invention for triggering a passenger protection arrangement having the features described herein have the advantage over the related art that the plausibility check is performed by the plausibility circuit on the basis of a signal from another control unit. It is thus possible to respond correspondingly easily to situations that are not deployment situations in the traditional sense. The accident signal does not indicate a deployment case in the traditional sense, but instead there is a situation which takes place before or after a crash. With the control unit according to the present invention and the method according to the present invention, it is now possible for this situation to also result in triggering of a passenger protection arrangement. The control unit according to the present invention and the method according to the present invention are capable of detecting such situations and performing the triggering. For this purpose, the plausibility circuit in the second hardware path therefore accepts a signal from another control unit and also enables the passenger protection arrangement as a function of this signal. At the same time, this means that the processor in the first hardware path detects a situation prevailing before or after the crash, for example. The processor in the first hardware path has a complex analysis algorithm, so it is therefore able to perform a pattern recognition, etc. easily on the basis of the accident signal according to the chronological characteristic. The plausibility circuit usually has a simpler design and has fixed thresholds, for example.

Consequently, it is possible according to the present invention to trigger the active and passive passenger protection arrangement before an accident and even after a first accident in a targeted manner. This is easily achieved according to the present invention because the plausibility circuit receives only one additional signal in addition to the accident signals. For this purpose, the plausibility circuit then has a corresponding signal processing function, e.g., simply to recognize an identifier of a control unit.

The following advantages are therefore obtained:
Deployment decisions may also be made centrally via a traditional deployment signal even with integration of systems of a combination of active and passive safety.
Unnecessary or double or parallel software development effort may be avoided, thus allowing cost savings.
Information inconsistencies among various software modules controlling the deployment may be reduced.
Generation of deployment decisions from modules relating to active and passive safety may also be harmonized with the safety concept pursued previously.

Advantageous improvements on the control unit and method for triggering the passenger protection arrangement defined in the independent patent claims are possible through the measures and further embodiments defined in the dependent claims.

It is advantageous in particular that the signal from the additional control unit originates from the control unit for the electronic stability program. It is thus possible to enable the passenger protection arrangement in such dangerous situations as skidding, etc. This means that a vehicle dynamics response is also evaluated from the accident signals in the processor in the first hardware path. For example, the lateral speed, the side slip angle, the rotational rates, etc. are determined. Triggering of the the passenger protection arrangement may thus be achieved on the basis of a vehicle dynamics response through this expanded analysis algorithm in the processor in the first hardware path and the plausibility check by the signal of the electronic stability program. The vehicle dynamics may also be used in the sense of a subsequent crash for preparing the passenger protection arrangement if a first crash has already taken place, possibly even a soft crash.

The algorithm in the control unit for the electronic stability program may advantageously also transmit status flags to the plausibility circuit. Software switches in the plausibility circuit may then be operated on the basis of these status flags. This then results in an enable signal. Measured values, calculated values and other possible data may also be transmitted instead of status flags. Possible status flags to be used include the fact that the electronic stability program algorithm is active, the fact that there has been an intervention of the electronic stability program algorithm and that the electronic stability program has failed, i.e., the vehicle could not be stabilized by the electronic stability program.

In addition, it is advantageously possible for a control unit that controls surroundings monitoring or a distance regulation, namely the known ACC, which detects by radar the distance at least to the preceding vehicle and then regulates the vehicle, to be used for the plausibility check according to the present invention. These surroundings monitoring data are of great benefit for subsequent crashes in particular. Deployment of the protection arrangement may then already be enabled at an early point in time to immediately deploy the protection arrangement when the analysis algorithm in the processor in the first path detects a subsequent crash.

The enable signal from the plausibility circuit may advantageously be such that it selects a certain passenger protection arrangement which are to be used even before or after an accident. For example, electric motor-operated seat-belt tighteners, crash-activated head restraints and extendible bumpers may be activated before the accident. After an accident, seat-belt tighteners, crash-activated head restraints and the airbags not yet deployed in the first crash may in turn be used.

Exemplary embodiments of the present invention are depicted in the drawings and explained in greater detail in the following description.

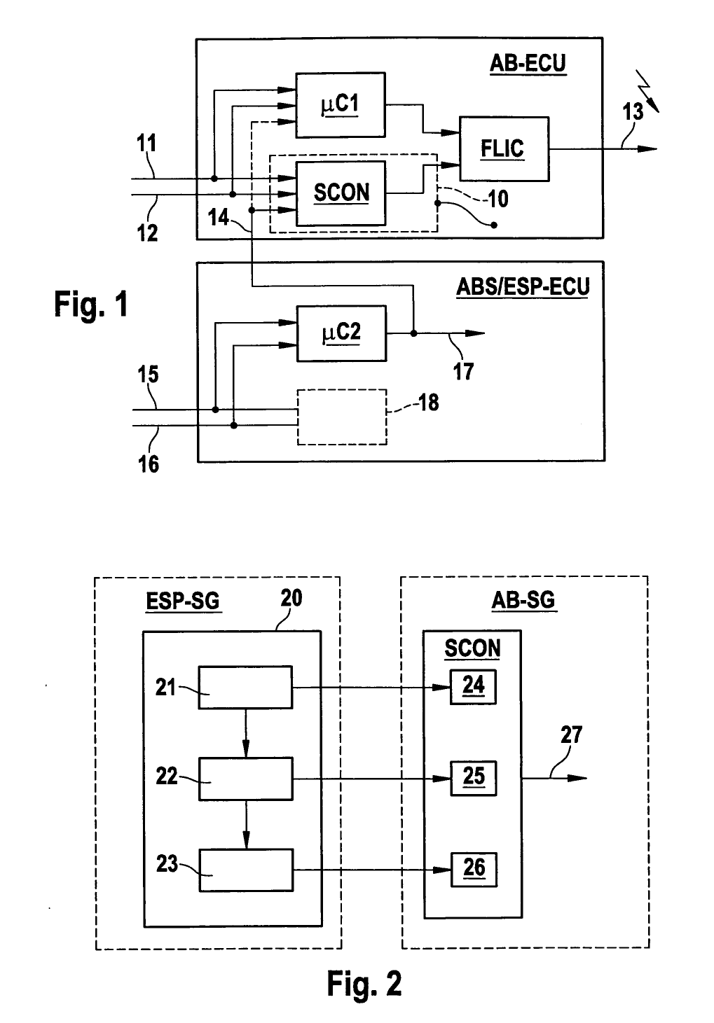

FIG. 1 shows a first exemplary embodiment of the control unit according to the present invention,

FIG. 2 shows an exemplary embodiment of the data transmitted from the control unit for the electronic stability program to the plausibility circuit in the airbag control unit,

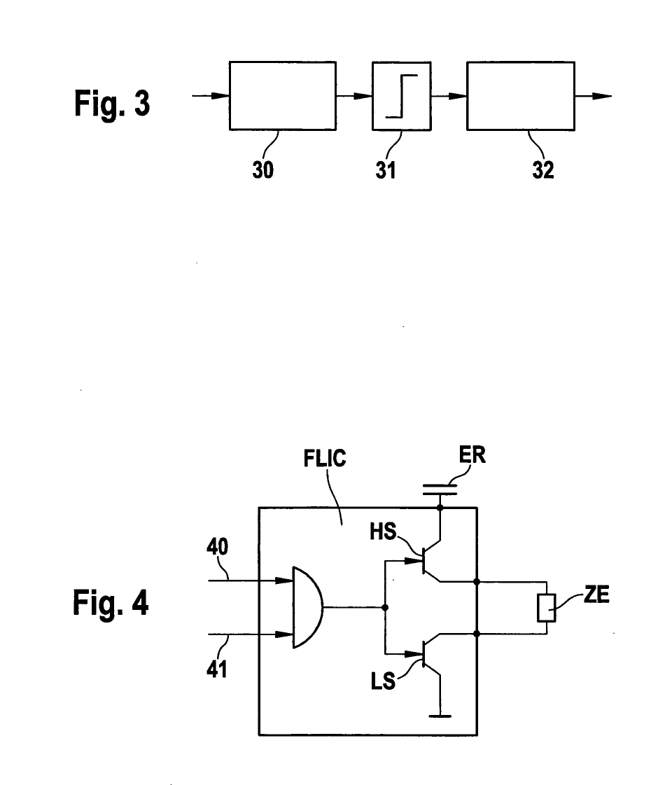

FIG. 3 shows an exemplary embodiment of the safety semiconductor,

FIG. 4 shows an exemplary embodiment of the triggering circuit, and

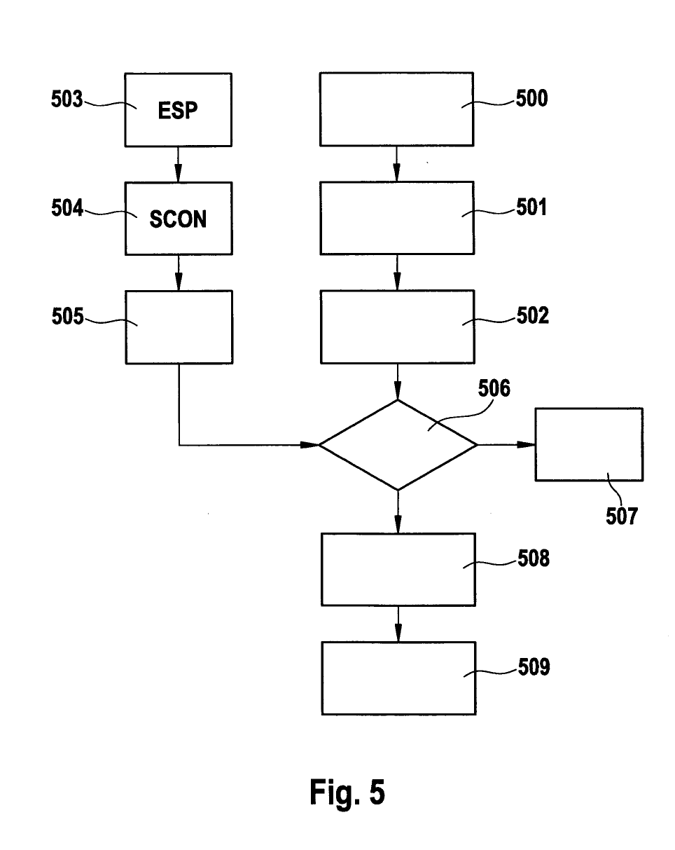

FIG. 5 shows a flow chart of the method according to the present invention.

FIG. 1 illustrates in a block diagram a first specific embodiment of the control unit according to the present invention. A control unit for the triggering passenger protection arrangement AB-ECU has two independent hardware paths. The first hardware path includes essentially microcontroller μC1 and its lines with respect to the sensor input and the output of the trigger signal to triggering circuit FLIC. Second hardware path 10 has plausibility circuit SCON. Plausibility circuit SCON receives the sensor signals from lines 11 and 12 in parallel with microcontroller μC1, namely from sensors outside of control unit AB-ECU. In addition or instead, accident sensors may also be present inside control unit AB-ECU. However, in the present case plausibility circuit SCON also receives a signal via an interface 14 from the control unit for electronic stability program ABS/ESP-ECU, which also uses plausibility circuit SCON for a plausibility check. The enable signal of plausibility circuit SCON is sent to triggering circuit FLIC, enabling this triggering circuit FLIC for the trigger signal of the microcontroller from analyzer circuit μC1. This signal from the control unit for electronic stability program ABS/ESP-ECU may also additionally but not necessarily be sent to microcontroller μC1, so that microcontroller μC1 is also able to analyze this signal.

The signal supplied via interface 14 in airbag control unit AB-ECU is generated by a microcontroller μC2 in the control unit for electronic stability program ABS/ESP-ECU, namely with its control algorithm for the electronic stability program. This signal 17, which is transmitted to plausibility circuit. SCON, is also used for the electronic stability program. Microcontroller μC2 also receives signals from a sensor system for the electronic stability program or the ABS system. These sensor signals are supplied via lines 15 and 16. Another processor 18 is also able to process the signals in parallel with microcontroller μC2.

Triggering circuit FLIC delivers the ignition current as ignition signal 13 to the passenger protection arrangement when microcontroller μC1 and plausibility circuit SCON have detected a deployment case. It is possible for microcontroller μC1 or plausibility circuit SCON to select the passenger protection arrangement to be triggered for the particular triggering case.

Microcontroller μC1 may ascertain vehicle dynamics data in addition to the crash data on the basis of accident signals 11 and 12 and evaluate them to detect a triggering case. This is to be taken into account before an accident in particular. Electronic stability program ABS/ESP-ECU also detects such a situation. To ensure the independent hardware path, the plausibility circuit evaluates the result of the electronic stability program to perform a plausibility check on the decision by microcontroller μC1 using its analysis algorithm. The ignition elements are energized only when both microcontroller μC1 and plausibility circuit SCON detect the triggering case. This device is based on the assumption that when the algorithm in microcontroller μC1 comes to a triggering decision on the basis of a situation that is critical in terms of vehicle dynamics, then at least the algorithm in the electronic stability program would have to have become active, perhaps even intervening in the vehicle dynamics in a regulating manner. If the driving status could no longer be stabilized by the electronic stability program, this would no doubt be a plausibility check of the triggering decision by microcontroller μC1.

As stated above, other control units may also deliver their signal to plausibility circuit SCON.

As shown in FIG. 1, microcontroller μC1 as the analyzer circuit and plausibility circuit SCON are separated in the hardware. This means that there are two independent hardware paths. This does not mean that microcontroller μC1 and plausibility circuit SCON are implemented on separate integrated circuits. It is possible for both microcontroller μC1 and plausibility circuit SCON to be present on a single semiconductor substrate but to have separate circuits.

Other components required for operation of the control units but unnecessary for an understanding of the present invention have been omitted here for the sake of simplicity.

FIG. 2 shows some signals which may be transmitted as the signal from the control unit for the electronic stability program to the plausibility circuit. FIG. 2 is to be understood primarily logically, i.e., the connecting lines need not be physically present; it is sufficient if there is a single line. ESP control unit ESP-SG for the electronic stability program is shown at the left. It has an algorithm 20, which is able to set a status flag 21 indicating that the electronic stability program algorithm is active. This may be transmitted to plausibility circuit SCON in control unit AB-SG for triggering the passenger protection arrangement. Another status flag is set when the electronic stability program algorithm intervenes in a regulating manner. This status flag is labeled here as 22 and is transmitted to plausibility circuit SCON. This is also true when status flag 23 has been set, indicating that the electronic stability program algorithm has failed. This is also transmitted to plausibility circuit SCON. Plausibility circuit SCON has three switches 24, 25, and 26, which are implemented electronically or in software and correspond to the particular status flags, each being set as a function of these status flags. If one of these status flags has been set, then enable signal 27 for triggering circuit FLIC is output.

FIG. 3 shows a simple exemplary embodiment of the plausibility circuit. In a first block 30, signals are preprocessed, e.g., filtered, smoothed, etc. Amplification is also possible here. In block 31, the signal is compared with a predefined threshold. This threshold value decision is to be understood in very general terms, so that here again it is possible to differentiate between a 0 and a 1. After the threshold value decision, it is possible to generate enable signal 32. This may then be transmitted in various data formats, e.g., in the data format of the SPI bus (serial peripheral interface). However, it is also possible to transmit it as a single pulse. All conceivable variations for implementation of plausibility circuit SCON are possible in the present case.

FIG. 4 shows a simple example of triggering circuit FLIC. The signal of microcontroller μC1 and the signal of safety semiconductor SCON arrive via lines 40 and 41. These signals are ANDed together in triggering circuit FLIC. The ANDed signal then goes to electrically controllable power switches HS and LS. Electrically controllable power switch HS is connected on one side to the collector or the source having an energy reserve ER, e.g., a capacitor, and is connected on the other side to a first terminal of ignition element ZE. Electrically controllable power switch LS is connected on the collector side or source side to the additional terminal of ignition element ZE and is connected to the other electrode to ground while the bases or gates are each triggered by the output signal of the AND gate. All components indicated in the FLIC are integrated into a single chip. It is possible to implement this as a discrete module or as a mixed form of discrete and integrated modules.

FIG. 5 shows a flow chart of a method according to the present invention. In method step 500, microcontroller μC1 calculates the vehicle dynamics from the accident sensor signals, e.g., the acceleration signals. In method step 501, the decision whether or not the passenger protection arrangement should already be triggered before a possible or probable accident is made based on these signals. In method step 502, a signal is then transmitted accordingly to triggering circuit FLIC. This signal is usually transmitted as an SPI signal. A check is then performed in method step 506 to ascertain whether triggering circuit FLIC has already been enabled. To do so, in method step 503 a signal is transmitted from the control unit for the electronic stability program to plausibility circuit SCON, namely in method step 504. In method step 504, the plausibility circuit checks on whether there is a deployment case. This may be done on the basis of measured values or status flags.

An ignition or enable signal is then transmitted in method step 505 to triggering circuit FLIC. If this is the case, triggering circuit FLIC becomes active in method step 506. However, if this is not the case, the method is terminated in method step 507. It goes further in method step 508 if there is to be a triggering of the passenger protection arrangement. To do so, a check is performed in method step 508 to determine which passenger protection arrangement are to be triggered. This may be selected through appropriate logic combinations in triggering circuit FLIC. In method step 509, triggering is ultimately performed by energization of the ignition elements. The active and passive passenger protection arrangement may be triggered in the present case.

1-10. (canceled)

11. A control unit for triggering a passenger protection arrangement, comprising:
a first hardware path having an analyzer circuit;
a second hardware path having a plausibility circuit, wherein the hardware paths together induce the triggering on the basis of at least one accident signal from an accident sensor system, the first hardware path having the analyzer circuit for processing the at least one accident signal and the second hardware path having the plausibility circuit, wherein at least the plausibility circuit is additionally connected to an interface which supplies a signal of at least one additional control unit, and the plausibility circuit also enables the triggering as a function of the signal.

12. The control unit of claim 11, wherein the signal originates from a control unit for the electronic stability program.

13. The control unit of claim 12, wherein the signal is at least one status flag of the electronic stability program.

14. The control unit of claim 11, wherein the signal originates from a control unit for monitoring the surroundings.

15. The control unit of claim 11, wherein a triggering circuit, which receives an enable signal from the plausibility circuit as a function of the signal, triggers passenger protection means that are to be used even before the accident or after the accident.

16. A method for triggering a passenger protection arrangement, the method comprising:
using a first hardware path and a second hardware path together to induce the triggering on the basis of at least one accident signal from an accident sensor system;
using an analyzer circuit in the first hardware path for processing the at least one accident signal and a plausibility circuit used in the second hardware path, wherein at least the plausibility circuit is additionally connected to an interface; and
using the interface to supply a signal of at least one additional control unit, wherein the plausibility circuit enables the triggering as a function of this signal.

17. The method of claim 16, wherein the signal originates from a control unit for the electronic stability program.

18. The method of claim 17, wherein at least one status flag of the electronic stability program is used as the signal.

19. The method of claim 16, wherein the signal originates from a control unit for monitoring the surroundings.

20. The method of claim 16, wherein as a function of the signal, the plausibility circuit enables the passenger protection arrangement, which is to be used before or after the accident.
